(19) United States
(12) Patent Application Publication
(10) Pub. No.: US 2024/0004935 A1
(43) Pub. Date: Jan. 4, 2024

(54) Chemistry, Manufacturing, and Controls Change Assessment System

(71) Applicants: Merck Sharp & Dohme LLC, Rahway, NJ (US); MSD IT INNOVATION CENTER S.R.O., Prague (CZ)

(72) Inventors: John William Baker, Pipersville, PA (US); Kyle Hayes, Lansdale, PA (US); Jose Colon Colon, Phoeniville, PA (US); Regis Antonio Gimenis, Aliso Viejo, CA (US); Sachin Lalit Doshi, Jersey City, NJ (US); Jacob Rege Klitzke, Seattle, WA (US); Michael Bain, Piscataway, NJ (US); Pavlo Dvornikov, Prague (CZ); Nicolas Rey Turner, Kirkland, WA (US); Peter Mezensky, Rahway, NJ (US); Craig Kennedy, Skillman, NJ (US); Mykyta Viazovskyi, Prague (CZ); Nikita Vostrosablin, Prague (CZ); Nirdosh Jagota, Malvern, PA (US); Marcy Newquist Huang, North Wales, PA (US)

(21) Appl. No.: 18/265,012

(22) PCT Filed: Nov. 30, 2021
(86) PCT No.: PCT/US2021/061255

§ 371 Date: Jun. 2, 2023

Related U.S. Application Data
(60) Provisional application No. 63/121,101, filed on Dec. 3, 2020.

(51) Int. Cl. G06F 16/9038; G06F 16/901

(52) U.S. Cl. CPC G06F 16/9038; G06F 16/901

(57) ABSTRACT

A user (e.g., a CMC scientist) identifies a change in CMC data for a regulated product, service, or system provided by an organization. A change assessment engine provides a recommendation for regulatory impact reporting. The recommendation may include a rationale and supporting evidence. The recommendation may identify the markets where the product, service, or system is registered, an indication of potential reportability in that market, specific health authority regulations that apply, and direct linkages into an internal regulatory knowledge repository of the organization. The change assessment engine may drive a user interface that guides users through the process in a consistent and repeatable manner.

### CROSS-REFERENCE TO RELATED APPLICATIONS

This application claims the benefit of U.S. Provisional Patent Application No. 63/121,101, entitled “Chemistry, Manufacturing, and Controls Change Assessment System, filed Dec. 3, 2020, which is incorporated by reference.

### TECHNICAL FIELD

This disclosure relates generally to chemistry, manufacturing, and controls (CMC) for regulated products, services, and systems; and, in particular, to a system for assessing and managing proposed changes in CMC data.

### BACKGROUND

CMC data for a regulated product (e.g., a pharmaceutical product) generally includes information about: the manufacturing process, quality control release testing, the specifications and stability of the product, and the manufacturing facility as well as any support utilities, including their design, qualification, operation, and maintenance. Many regulated products are manufactured, sold, and used in multiple jurisdictions. The regulatory requirements regarding submissions and treatment of changes in CMC data vary across jurisdictions and are frequently changing. This makes managing and ensuring conformance with regulatory requirements a challenging task. Existing solutions often involve human operators manually retrieving and checking multiple documents, which may be stored in multiple systems in multiple formats, on a case by case basis and making judgment calls. This is time consuming and may result in errors. Furthermore, different operators may take different approaches to reviewing changes, which can lead to systematically inconsistent results.

### SUMMARY

[4] A user (e.g., a CMC scientist) identifies a change in CMC data for a regulated product produced by an organization. A change assessment engine provides a recommendation for regulatory impact reporting along with a clear rationale and supporting evidence. This may include the markets where the product is registered, an indication of potential reportability in that market, specific health authority regulations that apply, and direct linkages into an internal regulatory knowledge repository of the organization. The change assessment engine may drive a user interface that guides users through the process in a consistent and repeatable manner. Thus, among other advantages, errors, the time taken to complete assessments, and/or differences between assessments performed by difference users may be reduced relative to conventional approaches.

In one embodiment, a computer-implemented change assessment method for a regulated product (e.g., a pharmaceutical product, a vaccine product, or a biological product, etc.) includes receiving identification of a change proposal and accessing change proposal data corresponding to the identified change proposal. The change proposal data is ingested from a plurality of data sources and supplemented based on a user's responses to questions relating to the change proposal. The method further includes applying a machine-learning model to the change proposal data to generate one or more classifications and providing, for display to the user, applicable matching criteria questions generated based on the classifications. The machine-learning model may be a natural language processing (NLP) model such as an Adaboost decision tree. Assessment results are generated responsive to the user's responses to the matching criteria questions and the assessment results are provided for display to the user. The assessment results may include the text of one or more regulations determined to be relevant to the change (or a mechanism to access the text of the relevant regulations).

[6] Ingesting the change proposal data may include retrieving data relating to the change proposal from each of the plurality of source datastores, converting the data relating to the change proposal into a standardized format to create a standardized change proposal record, and storing the standardized change proposal record in a change assessment datastore that is distinct from the plurality of source datastores. The change proposal data may include at least one of: a description of the change, a reason for the change, technical information relating to the change, a comment on the change, an identification of a product impacted by the change, or an identification of a production site impacted by the change.

The change proposal data may be stored in a graph that includes nodes and edges connecting pairs of nodes. The nodes store information about the regulated product and the edges indicate connections or correspondences between the information stored in the corresponding pairs of nodes. The change proposal may be represented in the graph by a change proposal node. The change proposal node may be connected by one or more edges to at least one of: a family node indicating a family of the regulated product, a classification node indicating a classification of the change proposal, a material node indicating a material impacted by the change, or a material type node indicating a type of the material impacted by the change.

[8] The questions asked to the user may include at least one of: prompting the user to identify a material impacted by the change, prompting the user to assign a type to the material impacted by the change, or asking the user whether product quality will be impacted by the change.

The matching criteria questions may be provided by identifying one or more regulations that are potentially relevant to the change, providing an indication of the one or more regulations for display to the user, and prompting the user to confirm whether the one or more regulations are relevant. The one or more regulations may be identified by querying a set of regulation mappings using the one or more classifications to identify the one or more regulations

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

FIG. 1 is a block diagram of a networked computing environment suitable for providing computer-assisted CMC change assessment, according to one embodiment.

FIG. 2 is block diagram of the change assessment data store of FIG. 1, according to one embodiment.

FIGS. 3A and 3B illustrate a data model for change proposals, according to one embodiment.

FIG. 4 is a block diagram of the change assessment system of FIG. 1, according to one embodiment.

FIG. 5 is a flowchart of a method for assessing a change proposal, according to one embodiment.

FIG. 6 is a flowchart of a method for refining an assessment, according to one embodiment.

FIG. 7 a block diagram illustrating components of an example machine able to read instructions from a machine-readable medium and execute them in a processor (or controller), according to one embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. Where similar or like elements are identified by a common numeral followed by a different letter, a reference to the numeral alone may refer to any such element or combination of such elements (including all such elements). The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

Broadly speaking, a change proposal is a proposal to change an aspect of a regulated product (e.g., its manufacture, testing, and/or labeling) that may or may not impact one or more existing marketing authorizations for that product. Similarly, a change assessment is the process by which employees of the enterprise (e.g., CMC scientists) evaluate whether and how the proposed change will impact the regulatory approvals and what actions should be taken in implementing the change to maintain regulatory compliance. For convenience, various embodiments are described below where the regulated products are pharmaceutical products, but it should be appreciated that the same or similar techniques may be applied to other regulated products (e.g., medical devices, food products, etc.).

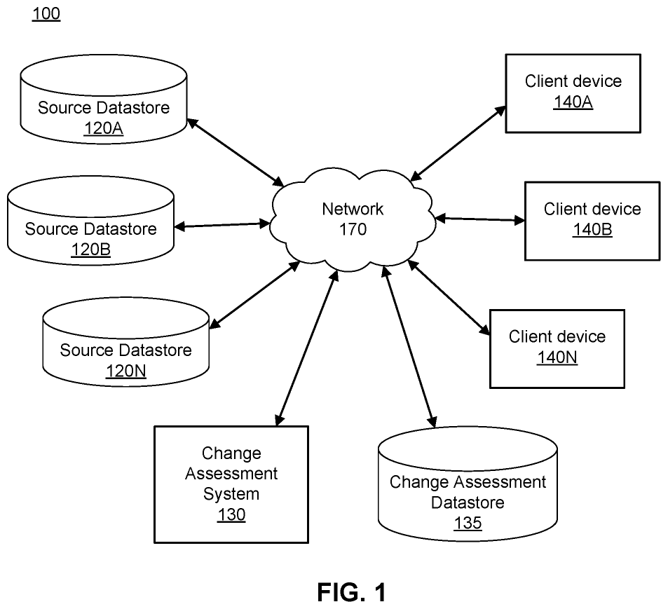

FIG. 1 illustrates one embodiment of a networked computing environment 100 suitable for providing semi-automated assessment of change proposals relating to the manufacture of pharmaceutical products. In the embodiment shown, the networked computing environment 100 includes a set of source datastores 120, a change assessment system 130, a change assessment datastore 135, and a set of client devices 140, all connected via a network 170. In other embodiments, the networked computing environment 100 includes different and/or additional elements. In addition, the functions may be distributed among the elements in a different manner than described.

The source datastores 120 include one or more non-transitory computer-readable storage media configured to store information about the pharmaceutical products manufactured by an enterprise (e.g., a pharmaceutical company). Enterprises that manufacture pharmaceutical products already store a large amount of data about their products, but this data is often stored across multiple systems. In the example shown in FIG. 1, the enterprise has data relevant to assessing change proposals stored in three source datastores 120A, 120B, and 120N. However, the networked computing environment may include any number of source datastores 120.

In one embodiment, the source datastores 120 include a regulatory intelligence datastore, a registrations datastore, and a supply chain datastore. The regulatory intelligence datastore includes information known to the enterprise regarding the regulatory framework in jurisdictions of interest, such as relevant markets, change types, regulatory requirements, and interpretations of regulatory requirements. The registrations datastore includes information regarding existing product registrations, such as jurisdictions with which registrations have been submitted for pharmaceutical products, the current status of those registrations (approved, pending, etc.), intended uses, manufacturing techniques, components, active ingredients, excipients, and the like. The registrations datastore may include copies of documents submitted to the corresponding regulators and/or indications of where such documents may be accessed (e.g., in the form of pointers to another datastore). The supply chain datastore includes information regarding the productions and distribution of pharmaceutical products, such as manufacturing locations, logistics, material inventory, material availability, sales, projected demand, and the like.

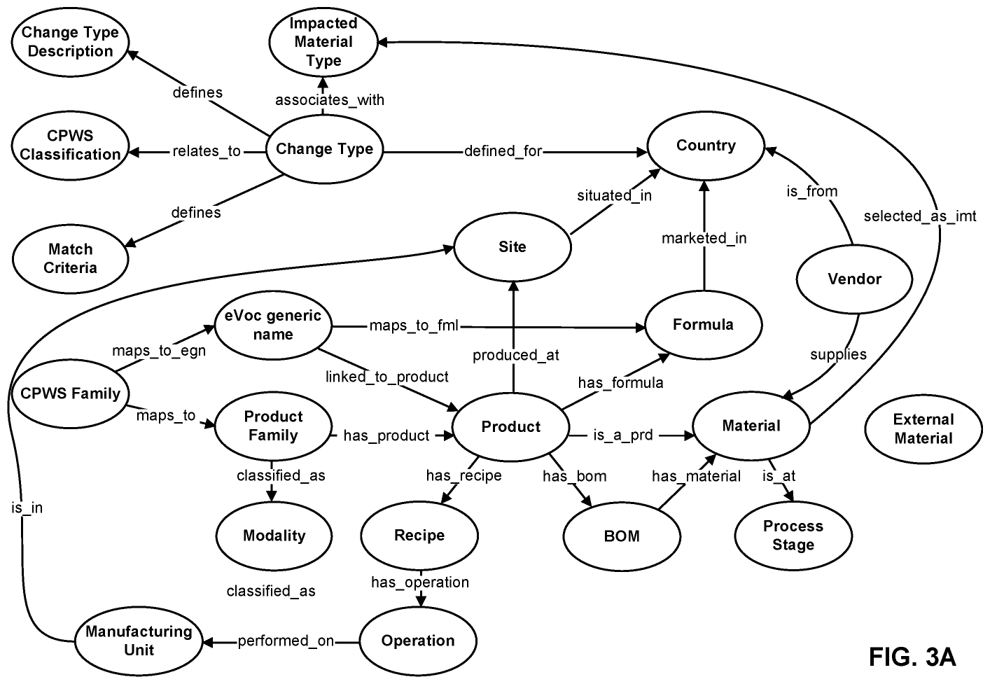

Conventional approaches to change proposal assessment require CMC scientists to manually access data from multiple data stores. This is a cumbersome task, further complicated by diverse and ever-changing regulatory requirements in different countries. The change assessment system 130 provides a semi-automated approach to assessing change proposals that may save a significant amount of time and effort for CMC scientists as well as reduce the number of errors. Furthermore, this approach may increase consistency between the assessments performed by different CMC scientists. Broadly speaking, the change assessment system 130 ingests data pertinent for the change assessment process from multiple source datastores 120 and stores the ingested data in a standardized format (e.g., in a graph database). The change assessment system 130 uses a mixture of responses to rule-based questions provided by the user and a machine-learning classifier to generate a recommended assessment of a change proposal that is reviewed and verified by the user. Various embodiments of the change assessment system are described in greater detail below, with reference to FIG. 3.

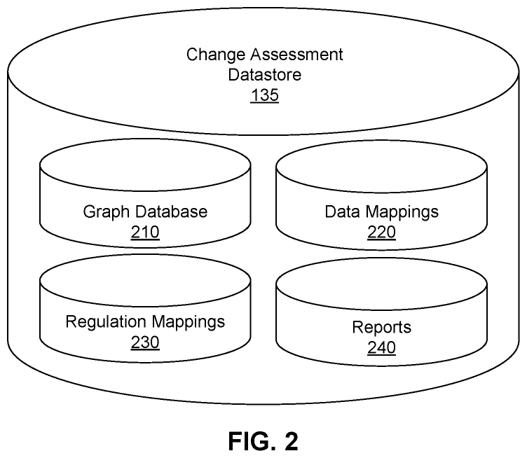

The change assessment datastore 135 includes one or more computer readable media configured to store the data ingested and used by the change assessment system 130. Although it is shown as a distinct entity (e.g., a distributed database) accessed via the network 170, the change assessment datastore 135 may be a part of the change assessment system 130. Various embodiments of the change assessment datastore 135 are described in greater detail below, with reference to FIG. 2.

The client devices 140 are computing devices with which users may access the change assessment functionality provided by the change assessment system 130. Although three client devices 140A, 140B, and 140N are shown in FIG. 1, the networked computing environment 100 may include any number of client devices 140. In one embodiment, a client device 140 is a computer system, such as a desktop or a laptop computer. Alternatively, a client device 140 may be a device having computer functionality, such as a personal digital assistant (PDA), a mobile telephone, a smartphone, or other suitable device. A client device 140 may execute software (e.g., an application) enabling a user of the client device 140 to interact with the change assessment system 130 via the network 170. For example, a client device 140 may execute a browser application that displays a user interface generated by the change assessment system 130.

The source datastores 120, change assessment system 130, change assessment datastore 135, and/or client devices 140 are configured to communicate via the network 170, which may include any combination of local area and/or wide area networks, using both wired and/or wireless communication systems. In one embodiment, the network 170 uses standard communications technologies and/or protocols. For example, the network 170 may include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, all or some of the communication links of the network 170 may be encrypted using any suitable technique or techniques.

FIG. 2 illustrates one embodiment of the change assessment datastore 135 that includes a graph database 210, data mappings 220, regulation mappings 230, and reports 240. In other embodiments, the change assessment datastore 135 may store different or additional data. Furthermore, the data may be arranged differently.

The graph database 210 is populated with data regarding the regulated pharmaceutical products extracted from the data stores. FIG. 3A illustrates an example graph database 210, according to one embodiment. In the example shown, the graph database 210 includes various information about the product stored as nodes in the graph, such as where it is made, the materials used, the recipe, and the like. The graph database 210 also includes edges that indicate connections or correspondences between the information stored in various nodes. For example, edges can indicate that the CPWS family of a product maps to a product family or that a particular manufacturing site is located within a specific country, etc.

The graph database 210 also includes information about a change type or types for countries in which the product is registered. FIG. 3B illustrates an example of how a change assessment may be represented within the graph database structure of FIG. 3A. In particular, FIG. 3B includes a node (designated CPWS) corresponding to the change proposal and four edges linking it to existing nodes in the graph database 210 for the corresponding CPWS family, material, impacted material type, and classification. These edges represent the results of the change assessment.

Referring back to FIG. 2, the data mappings 220 indicate the location in the source datastores 120 where the data used the populate the graph database 210 may be found. For example, the data mappings 220 might indicate that a particular column in a specific table in a first datastore indicates which countries a product is registered in while a particular set of columns in a specified table of a second datastore include the materials used and recipe for the product, etc. In other words, the data mappings 220 map the data stored across multiple source datastores 210 into the standardized format used by the change assessment system 130 (e.g., the graph database 210).

The regulation mappings 230 map specific change classifications and types to regulatory requirements in each jurisdiction of interest. The regulation mappings 230 convert unstructured regulations into structured data that may be input to a machine-learning model. In some embodiments, the regulation mappings 230 may be queried using a change classification to identify potentially relevant regulations. For example, the regulation mappings 230 may indicate that a change with a first classification (e.g., a change to the production site) has no regulatory impact in a first jurisdiction but a potential regulatory impact in a second jurisdiction. Similarly, a change with a second classification (e.g., a change to recipe used to manufacture the product) may have a potential regulatory impact in both jurisdictions. Where a change is classified as having a potential regulatory impact, the regulation mappings 230 may also indicate the corresponding regulation or regulations from the relevant health authority or authorities.

The reports 240 are documents storing the results of change assessments in an easily human-readable form. For example, the change assessment system 130 may generate printable reports indicating information such as the proposed change, the impacted product or products, and the potential regulatory impacts in a table or other suitable format. This may enable users to review previously completed assessments without going through the assessment process again as well as enable sharing with colleagues in a format that does not require special computing skills to interpret.

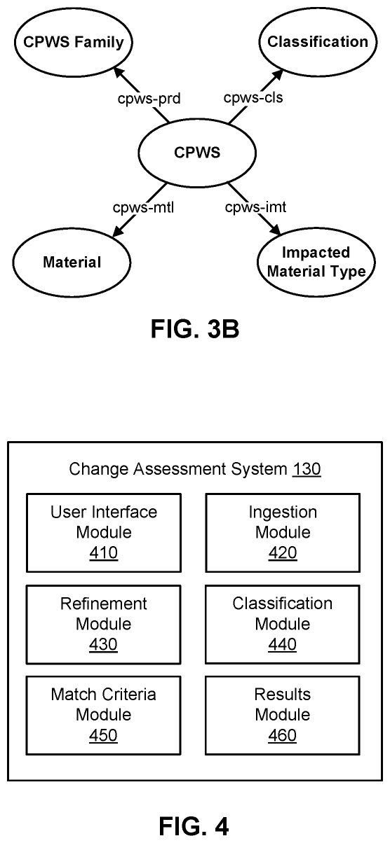

FIG. 4 illustrates one embodiment of the change assessment system 130. In the embodiment shown, the change assessment system 130 includes a user interface module 410, an ingestion module 420, a refinement module 430, a classification module 440, a match criteria module 450, and a results module 460. In other embodiments, the change assessment system 130 includes different and/or additional elements. In addition, the functions may be distributed among the elements in a different manner than described.

Referring back to FIG. 2, the user interface module 410 generates a user interface and provides it to the client devices 140 for display to users. The user interface is configured to step a user through the process of assessing a change proposal. In one embodiment, a user initiates a session between a user device 140 and the change assessment system 130 (e.g., by executing a change assessment application or directing a browser to a predetermined network address) and the user interface module 410 authenticates that the user is authorized to access the change assessment system 130 (e.g., by requesting a username and password, triggering a biometric identification process, or using any other suitable identity verification process).

Assuming the user is authenticated, the user interface provides controls for the user to select a change proposal to assess. For example, the user may select a change proposal by entering a change ID (also referred to herein as a CPWS ID or CPWS number). If an assessment has already been started for the entered change ID, the user may be given the option to continue the previous assessment. Otherwise, a new assessment begins. Additionally or alternatively, the user can begin an assessment for a change proposal defined in a locally stored file and/or open a previously-created assessment in read-only mode to view it without making changes.

The ingestion module 420 ingests change proposal data for the selected change proposal. In one embodiment, the change proposal data includes a description of the proposed change, a reason for the change, technical information (e.g., a scientific or otherwise technical explanation of the change being proposed), and/or any comments provided by the proposer, etc. The change proposal data may also include one or more products and production sites that are expected to be impacted by the change. The change proposal data is presented to the user for review/validation. The user may also be provided controls for providing information such as what category the change relates, whether it relates to a sterile or non-sterile product, and regulatory information. The user may also add, edit, or delete products and sites from those identified by the ingestion module 420 at this time.

The refinement module 430 prompts the user to answer questions to supplement the change proposal data. In various embodiment, the refinement module 430 prompts the user to identify materials impacted by the proposed change, provide a type for each impacted material (e.g., how the impacted material is used in producing a corresponding product), and indicate whether the proposed change will have an impact on product quality. In one such embodiment, the refinement module 430 presents the user with a list of materials associated with each product identified by the ingestion module 420 and the user selects one or more materials that will be impacted by the proposed change. For each impacted material selected, the user may select a type from a predetermined list of types (e.g., drug substance, intermediate substance, starting material, raw material, solvent, reagent, catalyst, process aid, excipient, intermediate (in-process material), finished drug product, diluent, container closure, medical device). For a given type, the list may be ordered based on the frequency with which each type is selected for that material in other instance. The user is presented with information relevant to the selected materials and material types as well as information ingested from the change proposal related to product quality. The user is then prompted to indicate whether the change potentially impacts product quality. Statements in the change proposal may be identified (e.g., by searching for sentences that include relevant keywords such as “quality” or “impact”) and presented to the user to aid in determining if there will be an impact on quality.

The classification module 440 applies a natural language processing (NLP) model (e.g., a machine-learning NLP model) to the selected impacted materials to generate recommended classifications. The NLP model may initially be trained on manually labelled data, such as change assessments completed using other approaches or any other suitable source of ground truth data. For example, the NLP model may be a decision tree boosted by an Adaboost approach, but other types of NLP model and training approaches may be used. Other examples of NLP models that may be used include a stochastic gradient descent (SGD) model with term frequency—inverse document frequency (TF-IDF) vectorization and a bidirectional encoder representations from transformers (BERT) that uses a multilabel sequence classification head. For possible classifications that are rare in the training data set, an oversampling algorithm such as ADASYN can be used to improve the training process for minority classes.

In one embodiment, the classification module 440 parses the change proposal and converts it into a standardized format used as input by the NLP model. Alternatively, the change proposal may have already been converted into the standardized format as part of the ingestion process. The input data for the NLP model may be preprocessed, such as by performing stemming, lemmatization, removal of potentially confusing words or phrases (e.g., manufacturer-specific terms or negative phrases), tokenization, and/or vectorization. The NLP model outputs a likelihood (e.g., a percentage) that each of a predetermined list of possible classifications applies for each impacted material for the current change proposal. The classification module 440 presents the possible classifications and indications of the corresponding likelihoods to the user. For example, the possible classifications may be presented in an ordered list (e.g., most to least likely) with the likelihood displayed next to each. Other visual indicators may be used to highlight the most or least likely classifications (e.g., the most likely classifications or any classifications with a likelihood above a threshold may be displayed in one color while others are displayed in another color). Alternatively, the user may initially just be presented with one or more suggested classifications (e.g., the most likely classification) and provided controls to reject the suggestion and suggest an alternative. One of skill in the art will recognize that there are many ways that suggested classifications and corresponding likelihoods may be presented to a user for confirmation.

As change proposals are assessed, user confirmation and adjustments to the suggested classifications may be used as feedback to retrain the NLP model. Thus, the NLP model may become more accurate over time as a greater variety of training data becomes available from on-going use.

The match criteria module 450 identifies one or more match criteria questions to present to the user based on the impacted material types, classifications, and countries in which the product is registered. In one embodiment, the match criteria module 450 identifies potentially relevant regulations and the match criteria questions prompt the user to confirm whether the identified regulations are relevant in a straightforward way. A particular material type and classification may potentially impact a large number of regulations. The match criteria questions guide the user through determining which regulations are relevant to the current change proposal by focusing in on the details of the relevant regulations (e.g., as indicated by the regulation mappings 230). For example, if the applicability of a particular regulation depends on whether the drug sterilization process is being changed, the user can be asked whether the sterilization process is impacted by the proposed change. Similarly, if the applicability of another regulation depends on whether the manufacturing process of a substance is being changed, the user can be asked whether the proposed change impacts the manufacturing process.

The results module 460 provides a summary of the results of the assessment to the user for review and confirmation. In one embodiment, the summary lists each market in which there is related product registration and indicates whether the change will likely have a regulatory impact. For jurisdictions where there is likely to be a regulatory impact, the summary may also indicate the relevant regulation or regulations and provide access to further information about the regulation (e.g., a copy of the text of the regulation and/or any pertinent interpretative material) through a popup box or link, etc. The summary may also include a description of the proposed changes, the answers the user provided to questions, the impacted materials and types, the selected classifications, technical information, and/or any other information that may be pertinent to the user in reviewing the results.

The results module 460 prompts the user to indicate either concurrence or non-concurrence with the results. If the user does not concur, the user may provide a rationale (e.g., in a provided text box). In some embodiments, the user may be required to provide a rationale for not concurring with the results before being able to complete the assessment. Regardless, once the user has reviewed the results summary and indicated concurrence or non-concurrence, the user may save the final results (e.g., to the change assessment datastore 135) and/or save a local copy (e.g., to a PDF file).

The approach described above can guide users through the process of evaluating a change proposal in a consistent and repeatable manner. Thus, variations between assessments performed by different users may be reduced relative to conventional approaches. The automated ingestion and use of NLP combined with the standardized approach can also significantly reduce the amount of time users spend evaluating each proposal. Furthermore, the user interface can provide links to underlying documents (e.g., to original copies stored in the source datastores 120) to enable efficient review in cases where the user determines that further investigation is pertinent, such as if information appears to be missing or incomplete.

### Example Methods

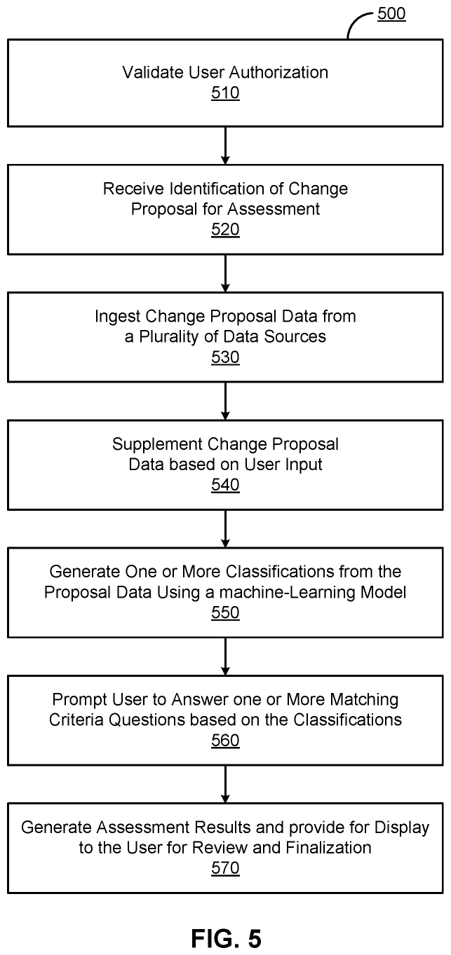

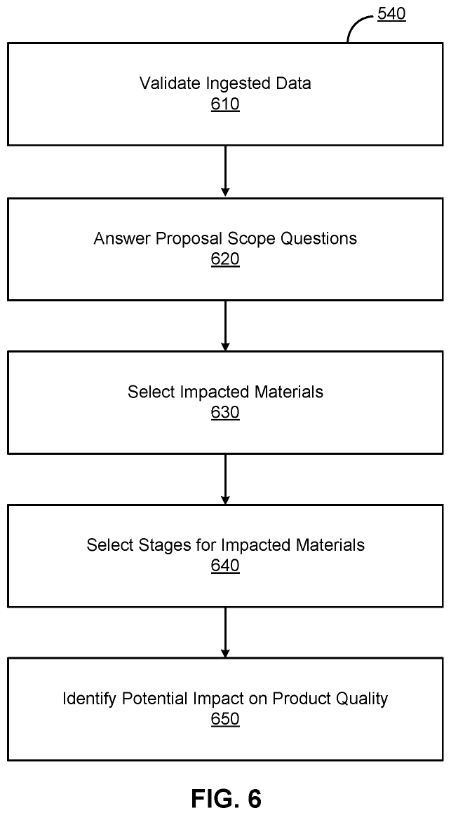

FIGS. 5 and 6 illustrate example methods relating to assessing a change proposal. The steps of FIGS. 5 and 6 are illustrated from the perspective of various components of the change assessment system 130 performing the methods. However, some or all of the steps may be performed by other entities and/or components. In addition, some embodiments may perform the steps in parallel, perform the steps in different orders, or perform different steps.

In the embodiment shown in FIG. 5, the method 500 begins with the change assessment system 130 validating 510 that the user is authorized to use the change assessment system 130. The user may have been notified that there are one or more change proposals awaiting their review, such as via an automated email generated by proposal submission or management system (not shown). Assuming the user is authorized, the change assessment system 130 receives 520 identification of a change proposal to be assessed. For example, the user may provide a change ID or otherwise identify a change proposal that has been submitted for assessment.

The change assessment system 130 ingests 530 change proposal data 530. As described above, the change assessment system 130 can use data mappings 220 to extract pertinent information from multiple data stores 120. Thus, the time the user spends searching for relevant information may be significantly reduced relative to conventional approaches. The change assessment system 130 supplements 540 the change proposal data by causing the user's client device 140 to display questions relating to the change proposal. For example, as shown in FIG. 6, the change assessment system 130 may prompt the user to validate 610 the ingested data, answer 620 proposal scope questions, select 630 impacted materials, select 640 stages for the impacted materials, and identify 650 potential impacts on product quality. Thus, the change assessment system 130 guides the user through the assessment process in a consistent and repeatable manner, reducing the likelihood of errors and providing greater consistency between different users.

Referring back to FIG. 5, the change assessment system 130 generates 550 one or more classifications from the supplemented change proposal data using a machine-learning model. As described previously, in one embodiment, the supplemented change proposal data identifies impacted materials and the machine-learning model generates likelihoods that possible classifications apply to each impacted material. The user selects the appropriate classification or classifications for each impacted material. The selected classifications may be fed back into the machine-learning model as part of a retraining process to improve the accuracy of future classification suggestions. The change assessment system 130 prompts 560 the user to answer one or more matching criteria questions that are generated based on the classifications. Based on the user's responses, the change assessment system 130 generates 570 assessment results and provides them for display to the user. The user may then review, edit, and finalize the results as appropriate.

### Computing Machine Architecture

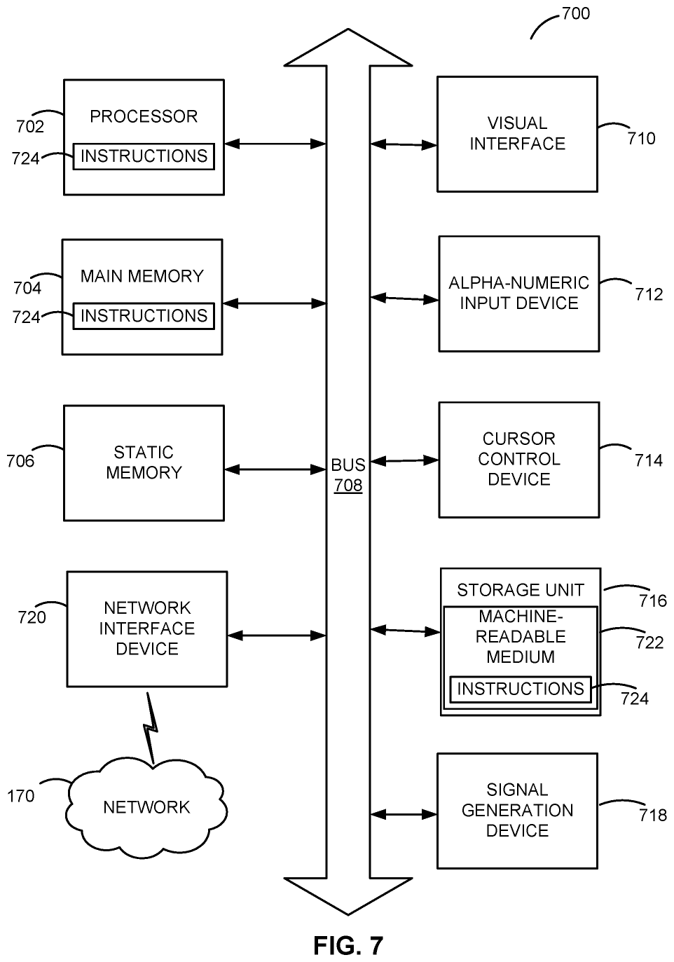

FIG. 7 is a block diagram illustrating components of an example machine able to read instructions from a machine-readable medium and execute them in a processor (or controller). Specifically, FIG. 7 shows a diagrammatic representation of a machine in the example form a computer system 700, within which program code (e.g., software or software modules) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 710 may include or may interface with a touch enabled screen. The computer system 700 may also include alphanumeric input device 712 (e.g., a keyboard or touch screen keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 170 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across one or more machines, e.g. computer system 700. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. It should be noted that where an operation is described as performed by “a processor,” this should be construed to also include the process being performed by more than one processor. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing CMC change assessment through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the disclosed principles.

1. A computer-implemented change assessment method for a regulated product, system, or service, the method comprising:
receiving identification of a change proposal;
accessing change proposal data corresponding to the identified change proposal, the change proposal data having been ingested from a plurality of source datastores;
supplementing the change proposal data based on a user's responses to questions;
applying, to the change proposal data, a machine-learning model to generate one or more classifications;
providing, for display to the user, one or more matching criteria questions that are generated based on the classifications;
generating assessment results responsive to responses to the matching criteria questions; and
providing the assessment results for display to the user.

2. The computer-implemented change assessment method of claim 1, further comprising ingesting the change proposal data from the plurality of source datastores.

3. The computer-implemented change assessment method of claim 2, wherein ingesting the change proposal data comprises:
retrieving data relating to the change proposal from each of the plurality of source datastores;
converting the data relating to the change proposal into a standardized format to create a standardized change proposal record; and
storing the standardized change proposal record in a change assessment datastore that is distinct from the plurality of source datastores.

4. The computer-implemented change assessment method of claim 1, wherein the change proposal data includes at least one of: a description of the change, a reason for the change, technical information relating to the change, a comment on the change, an identification of a product impacted by the change, or an identification of a production site impacted by the change.

5. The computer-implemented change assessment method of claim 1, wherein the change proposal data is stored in a graph, the graph including nodes storing information about the regulated product and edges, between pairs of the nodes, indicating connections or correspondences between the information stored in corresponding pairs of nodes.

6. The computer-implemented change assessment method of claim 5, wherein the change proposal is represented by a change proposal node in the graph, the change proposal node connected by one or more edges to at least one of: a family node indicating a family of the regulated product, a classification node indicating a classification of the change proposal, a material node indicating a material impacted by the change, or a material type node indicating a type of the material impacted by the change.

7. The computer-implemented change assessment method of claim 1, wherein the questions include at least one of: prompting the user to identify a material impacted by the change, prompting the user to assign a type to the material impacted by the change, or asking the user whether product quality will be impacted by the change.

8. The computer-implemented change assessment method of claim 1, wherein the machine-learning model is a natural language processing (NLP) model trained to generate recommended classifications for the change proposal based on text included in the change proposal data.

9. The computer-implemented change assessment method of claim 8, wherein the NLP model is an Adaboost decision tree.

10. The computer-implemented change assessment method of claim 1, wherein providing the one or more matching criteria questions comprises:
identifying one or more regulations that are potentially relevant to the change;
providing, for display to the user, an indication of the one or more regulations; and
prompting the user to confirm whether the one or more regulations are relevant.

11. The computer-implemented change assessment method of claim 10, wherein identifying the one or more regulations comprises querying a set of regulation mappings using the one or more classifications to identify the one or more regulations.

12. The computer-implemented change assessment method of claim 1, wherein providing the assessment results for display to the user comprises providing the user with access to text of one or more regulations determined to be relevant to the change.

13. The computer-implemented change assessment method of claim 1, wherein the regulated product is a pharmaceutical product, a vaccine product, or a biological product.

14. A non-transitory computer-readable storage medium comprising instructions for change assessment for a regulated product, service, or system, the instructions, when executed by a computing system, causing the computing system to:
receive identification of a change proposal;
access change proposal data corresponding to the identified change proposal, the change proposal data having been ingested from a plurality of source datastores;
supplement the change proposal data based on a user's responses to questions;
apply, to the change proposal data, a machine-learning model to generate one or more classifications;
provide, for display to the user, one or more matching criteria questions that are generated based on the classifications;
generate assessment results responsive to responses to the matching criteria questions; and
provide the assessment results for display to the user.

15. The non-transitory computer-readable storage medium of claim 14, further comprising instructions that cause the computing system to:
retrieve data relating to the change proposal from each of the plurality of source datastores;
convert the data relating to the change proposal into a standardized format to create a standardized change proposal record; and
store the standardized change proposal record in a change assessment datastore that is distinct from the plurality of source datastores.

16. The non-transitory computer-readable storage medium of claim 1, wherein the change proposal data is stored in a graph, the graph including nodes storing information about the regulated product and edges, between pairs of the nodes, indicating connections or correspondences between the information stored in corresponding pairs of nodes, and wherein the change proposal is represented by a change proposal node in the graph, the change proposal node connected by one or more edges to at least one of: a family node indicating a family of the regulated product, a classification node indicating a classification of the change proposal, a material node indicating a material impacted by the change, or a material type node indicating a type of the material impacted by the change.

17. The non-transitory computer-readable storage medium of claim 1, wherein the instructions that cause the computing system to provide the one or more matching criteria questions comprise instructions that cause the computing system to:
identify one or more regulations that are potentially relevant to the change;
provide, for display to the user, an indication of the one or more regulations; and
prompt the user to confirm whether the one or more regulations are relevant.

18. The non-transitory computer-readable storage medium of claim 17, wherein the instructions that cause the computing system to identify the one or more regulations comprise instructions that cause the computing system to query a set of regulation mappings using the one or more classifications to identify the one or more regulations.

19. The non-transitory computer-readable storage medium of claim 14, wherein the instructions that cause the computing system to provide the assessment results for display to the user comprise instructions that cause the computing system to provide the user with access to text of one or more regulations determined to be relevant to the change.

20. A change assessment system comprising:
one or more processors; and
a memory storing instructions that, when executed, cause the one or more processors to:
receive identification of a change proposal;
access change proposal data corresponding to the identified change proposal, the change proposal data having been ingested from a plurality of source datastores;
supplement the change proposal data based on a user's responses to questions;
apply, to the change proposal data, a machine-learning model to generate one or more classifications;
provide, for display to the user, one or more matching criteria questions that are generated based on the classifications;
generate assessment results responsive to responses to the matching criteria questions; and
provide the assessment results for display to the user.
